(19) United States
(12) Patent Application Publication
(10) Pub. No.: US 2004/0010671 A1
(43) Pub. Date: Jan. 15, 2004

(54) Method and memory adapter for handling data of a mobile device using a non-volatile memory

(75) Inventors: Fabritius Sampsa, Tampere (FI); Vihmalo Jukka-Pekka, Tampere (FI); Makela Jakke, Turku (FI)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/449,707

(22) Filed: May 29, 2003

(30) Foreign Application Priority Data
May 31, 2002 (WO) PCT/IB02/01929

(51) Int. Cl. G06F 12/00

(52) U.S. Cl. 711/165; 711/103; 711/112

(57) ABSTRACT

The present invention relates to a method, a memory adapter and a system for handling data in a fixed memory of a mobile device. The inventive concept provides non-volatile memory as a kind of cache memory for accessing mass storage, wherein the fixed memory comprises at least one non-volatile memory and at least one mass storage. An advantage of the invention is that in case of an unexpected power failure, the corruption of data can be avoided, which is particularly important when operating mobile devices. Further, the non-volatile memory acting as a cache memory increases the access speed of the mass storage. Moreover, from the terminal point of view, the access to the mass storage is simplified since data is only stored and retrieved from the non-volatile memory independent of the kind of mass storage combined with the non-volatile memory.

### CROSS-REFERENCE TO RELATED APPLICATIONS

This application claims priority under 35 USC §119 to International Patent Application No. PCT/IB02/01929 filed on May 31, 2002.

### TECHNICAL FIELD

The present invention relates to a method, a memory adapter, a mobile device and a system for handling data in a fixed memory associated with a mobile device. In particular, the present invention relates to handling of data in a fixed memory comprising a non-volatile memory and a mass storage for storing of data of the mobile device.

### BACKGROUND OF THE INVENTION

The number of portable processing devices within a certain country, such as mobile phones of the current generation, personal digital assistants (PDA), organizers, mobile terminals increases rapidly and provides an increasing number of applications. In parallel, the processing speed of the processing entities contained in portable processing devices, e.g. especially microprocessors, digital signal processors and the like, still follow the law of Moore, which describes an exponential growth of the complexity of such entities.

Both of these circumstances result in a growing number of applications having complex algorithms which require high processing speeds of the executing processing entity which is embedded in a corresponding powerful electronic environment. One typical problem of such a powerful environment is the provision of an adequate fixed memory which is required by portable processing devices with increasing abilities. The term “adequate fixed memory” primarily designates the capacity of the fixed memory, its data communication rate and the data integrity in case of unexpected power shutdowns.

For example, present and upcoming multimedia applications such as music and video related applications require both an increasing processing capability and a high data capacity of the fixed memory for storing or caching music and video related information, respectively. Moreover, the data communication rate determining the exchange of data between an application and the storing fixed memory is also essential for these kind of applications.

In case of portable processing devices which are usually powered by batteries, an unexpected loss of power has to be taken into consideration. An unexpected power failure can occur when the battery or accumulator is inadvertently removed from the portable processing device by the user. The difference of the processing speed of the portable processing device and the data communication rate of a comparatively slow fixed memory can result in a corruption of data. The data integrity has to be ensured by adapted means.

### SUMMARY OF THE INVENTION

The object of the invention is to provide a method, a memory adapter, a mobile device and a system for handling data of a fixed memory of a mobile device. At least a non-volatile memory, in particular a non-volatile random access memory (NVRAM), and at least a mass storage are provided as a fixed memory for storing data. The non-volatile memory offers higher data communication rate in comparison with a typical mass storage and in addition has the ability to hold data even in case of a loss of power.

The applications executed on the mobile device communicate data with the fixed memory through a memory adapter. Thereby, the memory adapter distributes and swaps the data in-between the non-volatile memory and the mass storage invisible to the applications storing and/or retrieving data from the fixed memory. Preferably, the mass storage is detachably connected. From the terminal point of view, the fixed memory always appears as one uniform memory independently of the number or kind of components included in the fixed memory. The total capacity of the fixed memory supplied to the mobile device results from the capacities of the non-volatile memory and mass storage.

Further, mass storage based on different technologies can be used without modifying the access thereto from the terminal point of view since the access, i.e. read and/or write operations, is obtained via the memory adapter.

The object of the invention are attained by a method, an apparatus and a computer program which are characterized by what is claimed in the accompanying independent claims. Further embodiments of the invention are the subject of the corresponding dependent claims.

According to an embodiment of the invention, a method for handling data in a fixed memory associated with a mobile device is provided. A memory adapter couples the fixed memory which includes at least one non-volatile memory and at least one mass storage. Data of the mobile device are received by the memory adapter to be stored in the fixed memory. The storage place of the data is specified, i.e. the data can be stored either in the non-volatile memory or in the mass storage. In case the non-volatile memory is specified for data storing, the received data is transmitted to the non-volatile memory to be stored therein. In case the mass storage is specified for data storing, the received data is transmitted to the mass storage to be stored therein.

Preferably, the specifying of the storage place of the data is based on a storage algorithm. The capacity of the non-volatile memory is virtually extended by the mass storage. Preferably, the storage algorithm performs the distribution of the data among the members of the fixed memory in an adapted and adequate way. Advantageously, the storage algorithm may offer the possibility to define certain data as data to be stored in the non-volatile memory to be fast accessible and to define certain other data as data to be stored in the mass storage, e.g. large amounts of data, to save capacity of the non-volatile memory. Further, the storage algorithm may operate in accordance with a priority rating and/or an access number rating. The storage algorithm can further take the power consumption of the mass storage into account and may optimize the power consumption by an adapted operation of the fixed memory.

According to a preferred embodiment of the invention, at least a part of data stored in the non-volatile memory is retrieved therefrom. The retrieved data is transmitted to the mass storage included in the fixed memory to be stored therein.

According to a preferred embodiment of the invention, the data retrieved from the non-volatile memory is removed from the non-volatile memory subsequent to the retrieving.

According to a preferred embodiment of the invention, the data retrieved from the non-volatile memory is processed prior to transmitting the retrieved data to the mass storage. The processing of the retrieved data is operated in order to meet requirements, properties determined by the mass storage when receiving the data to be stored therein. The processing can be a mapping, an adapting or a modifying of the data.

According to a preferred embodiment of the invention, the retrieving of at least a part of data stored in the non-volatile memory comprises an identifying of at least a part of said stored data in accordance with a relocating algorithm. The relocating algorithm is employed to identify data for relocating to the mass storage in a preferable way. A relocating algorithm may offer the possibility to define certain data as data persisting in the non-volatile memory to be fast accessible. Other kinds of data may be relocated every time they are stored in the non-volatile memory. Further, a relocating algorithm may operate in accordance with a priority rating and/or an access number rating. The relocating algorithm can further take the power consumption of the mass storage into account and may optimize the power consumption by an adapted operation of the mass storage.

According to a preferred embodiment of the invention, data of the mobile device is read out into the fixed memory by receiving a request. The request instructs the memory adapter to retrieve certain data from the fixed memory of the mobile device and to transmit the retrieved data. The request instructs the data to be retrieved from the fixed memory. In accordance with the request and the storage place of the data, the requested data is retrieved from either the non-volatile memory or the mass storage. In case the requested data is stored in the non-volatile memory, the data is retrieved from the non-volatile memory and transmitted in accordance with the request. In case the requested data is stored in the mass storage, the data is retrieved from the mass storage and transmitted in accordance with the request. The storage place of the requested data is determined by the aforementioned distribution of the data among the non-volatile memory and the mass storage preferably performed by a storage algorithm.

According to an embodiment of the invention, at least a part of the requested data is retrieved from the mass storage included in the fixed memory. The data retrieved from the mass storage is transmitted to the non-volatile memory to be stored therein.

According to an embodiment of the invention, the data retrieved from the mass storage is removed from the mass storage subsequent to the retrieving.

According to an embodiment of the invention, the data retrieved from the mass storage is at least a part of the requested data is processed. The processing of the retrieved data is operated in order to meet requirements, properties determined by the non-volatile memory from the receiving of data to be stored therein. The processing can be a mapping, an adapting or a modifying of the data.

According to an embodiment of the invention, the mobile device is a mobile terminal device, particularly a mobile terminal device or a mobile phone, able to communicate via a wireless communication network.

According to an embodiment of the invention, the retrieving of at least a part of data stored in the mass storage comprises an identifying of at least a part of the stored data in accordance with a relocating algorithm. The relocating algorithm is employed to identify data for relocating to the non-volatile memory in a preferable way. The relocating algorithm may be based on a speculation algorithm which may offer a forward reading or a blockwise reading of data.

According to an embodiment of the invention, a software tool for handling data in a fixed memory of a mobile device is provided. The software tool comprises program portions for carrying out the operations of the aforementioned methods when the software tool is implemented in a computer program and/or executed.

According to an embodiment of the invention, there is provided a computer program for handling data in a fixed memory of a mobile device. The computer program comprises program code sections for carrying out the operations of the aforementioned methods when the program is executed on a processing device a computer or a network device.

According to an embodiment of the invention, a computer program product is provided which comprises program code portions stored on a computer readable medium for carrying out the aforementioned methods when said program product is executed on a processing device, a computer or network device.

According to an embodiment of the invention, a memory adapter for handling data in a fixed memory of a mobile device is provided. The fixed memory includes at least one non-volatile memory and one mass storage. The memory adapter is connected to the non-volatile memory and to the mass storage. The memory adapter is at least adapted to store data of the mobile device in the fixed memory. For this purpose, the memory adapter includes a component for receiving data to be stored in the fixed memory and a component for handling the received data which specifies the storage place of the received data, i.e. to determine if the received data is to be stored in either the non-volatile memory or in the mass storage. In case the received data is to be stored in the non-volatile memory, the memory adapter further comprises a component for transmitting the received data to the non-volatile memory to be stored therein. In case the received data is to be stored in the mass storage, the memory adapter additionally comprises a component for transmitting the received data to the mass storage. Preferably, the component for specifying operates in accordance with the aforementioned storage algorithm.

According to an embodiment of the invention, data is handled in the fixed memory through the memory adapter such that the fixed memory appears as one single uniform memory to e.g. applications executed on the mobile device and handling data in the fixed memory, i.e. storing and/or retrieving data, independently of the real number of components comprised in the fixed memory for storing data. The total capacity of the fixed memory results from the single capacitates of the components available to the memory adapter.

According to an embodiment of the invention, the memory adapter is further able to operate the aforementioned operations of the methods according to embodiments of the invention. Preferably, the memory adapter comprises further components for executing the aforementioned operations.

According to an embodiment of the invention, the memory adapter comprises a data interface for receiving data to be stored in said fixed memory, for receiving requests for data and for transmitting requested data and a memory interface to transmitting data to be stored to said non-volatile memory and for retrieving data requested from said non-volatile memory. Further, the memory adapter preferably comprises a mass storage interface for transmitting data to be stored to said mass storage and for retrieving data requested from said mass storage or at least an I/O port connected to such a mass storage interface, respectively. Preferably, the specifying of the storage place and the relocating of the data in-between the non-volatile memory and the mass storage is operated by an adapter core.

According to an embodiment of the invention, the memory adapter contains the non-volatile memory. More preferably, the memory adapter is contained in the non-volatile memory and/or in the mobile device.

According to an embodiment of the invention, a mobile device having a memory adapter for handling data in a fixed memory of a mobile device is provided. The fixed memory includes at least one non-volatile memory and one mass storage. The memory adapter is connected to the non-volatile memory and to the mass storage. The memory adapter is at least adapted to store data of the mobile device in the fixed memory. For this purpose, the memory adapter includes a component for receiving data to be stored in the fixed memory and a component for handling the received data which specifies the storage place of the received data, i.e. to determine if the received data is to be stored in either the non-volatile memory or in the mass storage. In case the received data is to be stored in the non-volatile memory, the memory adapter further comprises a component for transmitting the received data to the non-volatile memory to be stored therein. In case the received data is to be stored in the mass storage, the memory adapter additionally comprises a component for transmitting the received data to the mass storage. Preferably, the component for specifying operates in accordance with the aforementioned storage algorithm.

According to an embodiment of the invention, the memory adapter described above with reference to the mobile device is a memory adapter of the aforementioned type and relates to the description of the memory adapter above.

According to a preferred embodiment of the invention, the non-volatile memory is contained in the mobile device.

According to an embodiment of the invention, the mass storage is connected externally to the mobile device, preferably, the mass storage is detachably connected thereto. The connection of the mass storage to the mobile device can base on a large number of different available standards. Both wire-based and wireless connections can be employed. Typical wire-based connections are established to the external mass storage via the universal serial bus (USB) and the Firewire bus but also memory buses, e.g. for compact flash cards, MultiMediaCards or Secure Digital memory cards may be adapted to connect the external mass storage. Typical wireless connections are established to the external mass storage via Bluetooth interface, WLAN (wireless local area network) interface or an IRDA (infra red) interface. Additionally, a proprietary basic connection via a serial or parallel data bus may be employed.

According to an embodiment of the invention, the mobile device is a mobile terminal device, particularly a mobile device able to communicate via a wireless communication network such as a mobile phone.

According to an embodiment of the invention, a system for handling data in a fixed memory of a mobile device is provided. The system comprises a mobile device providing data, a memory adapter and the fixed memory including at least one non-volatile memory and at least one mass storage. The memory adapter is connected to the non-volatile memory and the mass storage, wherein the memory adapter is at least adapted to store data in the fixed memory. For this purpose, the memory adapter includes a component for receiving data to be stored in the fixed memory and a component for handling the received data which specifies the storage place of the received data, i.e. to determine if the received data is to be stored in either the non-volatile memory or in the mass storage. In case the received data is to be stored in the non-volatile memory, the memory adapter further comprises a component for transmitting the received data to the non-volatile memory to be stored therein. In case the received data is to be stored in the mass storage, the memory adapter additionally comprises a component for transmitting the received data to the mass storage. Preferably, the component for specifying operates in accordance with the aforementioned storage algorithm.

According to an embodiment of the invention, the memory adapter described above with reference to the system is a memory adapter of the aforementioned type and relates to the description of the memory adapter above.

According to an embodiment of the invention, the mobile device described above with reference to the system is a mobile device of the aforementioned type and relates to the description of the mobile device above.

### BRIEF DESCRIPTION OF THE DRAWINGS

The invention will be described in greater detail by the means of preferred embodiments with reference to the accompanying drawings, in which

FIG. 1a shows a generic block diagram illustrating the data flow between components with respect to an embodiment of the invention,

FIG. 1b shows a generic block diagram illustrating the data flow between components with respect to a further embodiment of the invention,

FIG. 2a shows a flow diagram illustrating an exemplary operational sequence for receiving data to be stored according to an embodiment of the invention,

FIG. 2b shows a flow diagram illustrating an exemplary operational sequence for receiving data to be stored according to an enhanced embodiment of the invention,

FIG. 3a shows a flow diagram illustrating an exemplary operational sequence for transmitting data to be retrieved with respect to an embodiment of the invention,

FIG. 3b shows a flow diagram illustrating an exemplary operational sequence for transmitting data to be retrieved with respect to an enhanced embodiment of the invention,

FIG. 4a shows a flow diagram illustrating a first exemplary operational sequence for swapping data in between non-volatile memory and mass storage according to an embodiment of the invention,

FIG. 4b shows a flow diagram illustrating a second exemplary operational sequence for swapping data in between non-volatile memory and mass storage according to an embodiment of the invention,

FIG. 5a shows a block diagram illustrating components of a mobile device having an external mass storage according to an embodiment of the invention,

FIG. 5b shows a block diagram illustrating components of a system comprising a mobile device and a mass storage unit according to an embodiment of the invention, and

FIG. 6 shows a block diagram illustrating components of a memory adapter according to an embodiment of the invention.

### DETAILED DESCRIPTION

The following description relates to the method, to the component, to the mobile terminal and to the system according to embodiments of the invention. Same or equal parts shown in the figures will be referred by the same reference numerals.

In principle, the inventive concept relates to an electronic device for processing and managing of electronic data which preferably is based on a processing entity such as a microprocessor. The operation of the electronic device is controlled by applications executed by the microprocessor. The applications and the microprocessor executing the applications are able to access a storage system, respectively, particularly a file system or a memory system to handle electronic data necessary for executing the applications. Conventionally, a data communication bus is employed to access the electronic data stored in the storage system. More particularly and in view of the introducing part of the description above, the inventive concept relates to a memory adapter of such an electronic device.

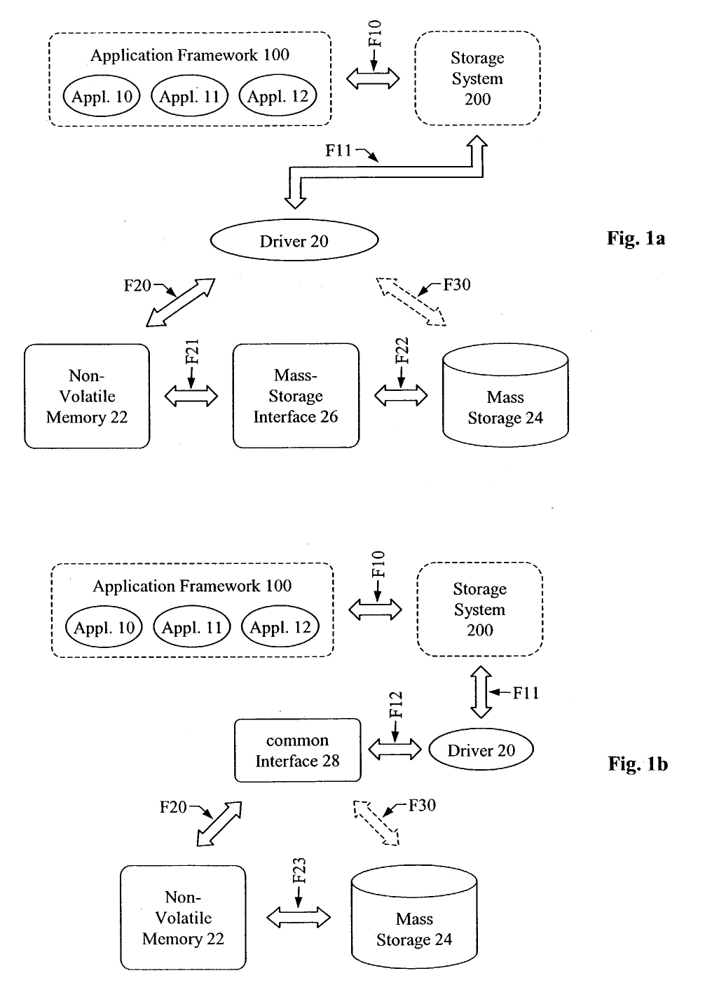

The following figures illustrate generic components and data flows by the means of two embodiments for describing the inventive concept. FIG. 1a as well as FIG. 1b depict an application framework 100 containing a set of exemplary applications 10, 11 and 12 representing an arbitrary number of applications executed by an electronic device. The execution of applications (here applications 10, 11 and 12) contained in the application framework 100 requires accessible memory for handling data, i.e. for reading and writing instructional and/or parametric data. The concept of the present invention relates to fixed memory for handling data. An application interface, the storage system 200, are provided to the applications of the application framework 100 for accessing the fixed memory. The data flow between application framework 100 and storage system 200 is illustrated by a data flow path F10. A driver 20 further directs the data flow from the storage system 200 to the respective fixed memory. The data flow between storage system 200 and driver 20 is indicated in FIG. 1a as well as in FIG. 1b by a data flow path F11.

The storage system 200 can be understood as a logical interface to the application framework 100 and its applications for accessing available data storage components for data handling, whereas the driver 20 can be understood as an intermediate interface of the logical interface provided by the storage system 200 to the application framework 100 to the physical properties and requirements of the physically involved storage component.

FIG. 1a illustrates the data flow between components with respect to an embodiment of the invention. The driver 20 is able to communicate data via a first data flow (illustrated by a data flow path F20) to a non-volatile memory 22. A further data flow can be established via a mass storage interface 26 between the non-volatile memory 22 and a mass storage 24. The corresponding data flow is depicted by data flow paths F21 and F22.

One application of the exemplary applications 10, 11 or 12, e.g. application 10, may access the storage system 200 for handling data, i.e. reading or writing data, respectively. The data is managed by the means of the storage system 200 and the driver 20 controlling the data communication to the non-volatile memory 22. Comprehensively, data communication of the applications 10, 11 or 12 constitutes read or write access operations of data to the non-volatile memory 22.

The non-volatile memory 22 has a certain data capacity and offers a certain data communication rate. The mass storage interface 26 interconnects the non-volatile memory 22 and the mass storage 24. The interconnection of the non-volatile memory 22 and the mass storage 24 enables data exchange between them, that is, on the one hand, the mass storage 24 is used as a swapping memory expanding the data capacity of the non-volatile memory 22 and on the other hand, the non-volatile memory 22 is used as a data cache of the mass storage 24 allowing a higher data communication rate in comparison with a direct access to the mass storage 24.

The swapping capability allows the swapping of data between the non-volatile memory 22 and the mass storage 24 via the mass storage controller 26 controlling the swapping operation. Swapping operations are hidden to the exemplary applications 10, 11 and 12 of the application framework 100. The applications 10, 11 and 12 only access the non-volatile memory 22 by the means of the storage system 200 and driver 20, both directing the communicated data in between.

The data access of the applications 10, 11 and 12 is simplified since the interconnected mass storage controller 26 operates the swapping operation. Modifications due to the use of different mass storage technologies for the mass storage 24 only concern the interconnected mass storage controller 26. Consequently, the non-volatile memory reports a data capacity which results from the data capacity of the non-volatile memory itself plus the connected mass storage 24 or the capacity of the mass storage 24 involved in the data swapping.

The data cache capability of the non-volatile memory 22 enhances the read and/or write accesses to the mass storage since the accesses are performed by the non-volatile memory 22 which offers a higher data communication rate for read and/or write accesses than the mass storage 24.

Additionally, the driver 20 may be also able to communicate directly data via a second data flow (illustrated by a data flow path F30) to a mass storage. The direct communication without using the capabilities offered by the non-volatile memory corresponds to the traditional connecting of a mass storage to a processing device. In some cases a direct communication may be advantageous.

FIG. 1b illustrates the data flow between components with respect to a further embodiment of the invention. Here, the driver 20 communicates between the storage system 200 and a common interface 28 illustrated by data flow paths F11 and F12. The common interface 28 enables the communication to the non-volatile memory 22 as well as to the mass storage 24, wherein the respective data flows are illustrated by data flow paths F20 and F30.

Analogously, the non-volatile memory is accessed for read and/or write operations by the exemplary applications 10, 11 and 12 of the application framework 100. Again, the mass storage 24 is used as swapping memory expanding the data capacity of the non-volatile memory 22 and the non-volatile memory 22 is used as a data cache for enhancing the data communication rate of the mass storage 24. The data flow due to the communication of data between the non-volatile memory 22 and the mass storage 24 is depicted by data flow path F23.

Preferably, the data flow between non-volatile memory 22 and mass storage 24 represented by the data flow path F23 can be passed on by the common interface 28 such that correspondingly the data flow through data flow path F23 is replaced by data flow through data flow path F20 and F30 via the common interface 28.

More preferably, the common interface 28 is able to distribute received data between the non-volatile memory 22 and the mass storage 24. The distribution of the data is based on a storage algorithm hidden to the applications of the application framework 100. Requested data is retrieved from the respective storage place, i.e. either the non-volatile memory 22 and the mass storage 24, corresponding to the previous assigned storage place during the storing operation.

It shall be noted that the non-volatile memory relates to traditional non-volatile random access memory (NVRAM) such as a memory component combining SRAM (static random access memory) and a shadow EEPROM (electronically erasable programmable read-only memory) or memory components basing on flash technology. Further, the non-volatile memory also relates to emerging memory technology, i.e. ferroelectric RAM (FeRAM) components, magnetoresistive RAM (MRAM) and the like. Conveniently, in accordance with the inventive concept, the non-volatile memory relates to any non-volatile memory, i.e. either any existing non-volatile memory or non-volatile memory of future development, offering a fast handling of data, i.e. reading and writing. The term “fast” shall express that the used non-volatile memory allows faster data handling in comparison to the mass storage and the data handling performance of the non-volatile memory is adapted to the performance of the processing unit accessing the non-volatile memory.

It shall be further noted that the mass storage relates to traditional mass storage technology for example hard discs. Further the mass storage also relates to emerging technology, i.e. polymer memory technology or micro electromechanical systems (MEMS) which is expected to offer sufficient data communication rates but which is of course unknown and possibly will not fulfill the expectations. Moreover, even available memory technology like the MultiMediaCard or secure digital (SD) memory card standard and flash memory technology have an undesired high latency of time for accessing data. This latency of time primarily concerns the data integrity in case of a power failure. For example, in case of a MultiMediaCard a write cycle can last up to 7 ms and a power failure within such a write cycle leads to a large loss of data.

Moreover, for the linking of the mass storage 24 a large number of connections based on different available standards are available. The mass storage 24 may be connected via typical buses such as a universal serial bus (USB), a Firewire bus or a wireless Bluetooth connection. Additionally, also a proprietary basic connection may be employed.

The advantages of the inventive concept can be seen clearly from the above illustrated generic data flow diagrams depicted in FIG. 1a and FIG. 1b, respectively. The data integrity of the fixed memory is ensured by the use of the non-volatile memory acting as a cache memory in combination with the mass storage. In parallel, the data communication rate of the non-volatile memory determines the data communication rate of the system comprising the non-volatile memory and mass storage. From the terminal point of view, especially from the application framework point of view, the handling of data of the provided fixed memory is determined by the non-volatile memory and independent from the mass storage, particularly from the employed technology. Only the mass storage interface 26 or the common interface 28 have to be adapted to the employed technology of the mass storage.

The following figures illustrate flow diagrams of exemplary operational sequences which may be operated in order to perform the inventive method according to embodiments of the invention. The depicted operational sequences are split into several individual operational sequences in order to illustrate the inventive concept in an exemplary and clear manner without limiting the invention and what is claimed thereto.

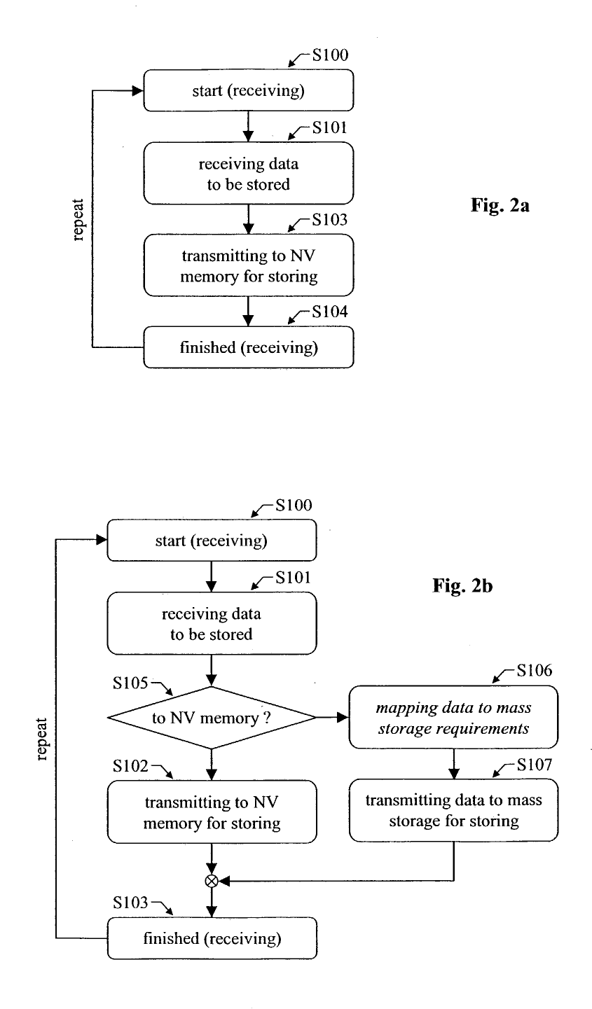

FIG. 2a and FIG. 2b illustrates exemplary operational sequences for storing electronic data of a mobile terminal device. FIG. 2a depicts a first exemplary operational sequence, whereas FIG. 2b depicts a second exemplary operational sequence which includes the exemplary operations of FIG. 2a and extends the described operational sequence by additional operations.

FIG. 2a illustrates a first exemplary operational sequence for receiving data to be stored according to an embodiment of the invention.

In an operation S100, an operational sequence for receiving data to be stored is initiated. The operational sequence may be in a standby operational mode or halt mode, respectively, and the depicted operational sequence may be started when necessary, e.g. on a receiving of data to be stored or on a receiving of a corresponding dedicated signal.

In an operation S101, data to be stored are received. The data is received to be stored in the non-volatile memory.

In an operation S102, the received data is transmitted to the non-volatile (NV) memory to be stored therein and preferably, the data is stored in the non-volatile memory.

In an operation S103, the data is stored in the non-volatile (NV) memory and hence the operational sequence relating to a storing of the received data is completed. Preferably, the operational sequence is repeated beginning with operation S100.

FIG. 2b illustrates a second exemplary operational sequence for receiving data to be stored according to an embodiment of the invention.

The operations S100 to S103 are analogous or identical to the operations S100 and S103 presented and described with reference to FIG. 2a.

In an operation S100, an operational sequence for receiving data to be stored is initiated. The operational sequence may be in a standby operational mode or halt mode, respectively, and the depicted operational sequence may be started when necessary, e.g. on a receiving of data to be stored or on a receiving of a corresponding dedicated signal.

In an operation S101, data to be stored is received. The received data may be stored in the non-volatile memory or may be stored in the mass storage.

In an interposed operation S105, the operational sequence branches into two branches. The first branch contains an operations S102, wherein this operation S102 relates to the storing of data in the non-volatile memory. The second branch contains operations S106 and S107 and relates to the directly storing of the received data in the mass storage by ignoring the non-volatile memory. The specifying of the storage place is based preferably on a storage algorithm. Conveniently, information relating the storage place may be received in combination with the data or may be included in the data. The information instructs to store the data either in the non-volatile (NV) memory or in the mass storage.

In the operation S102 of the first branch, the received data is transmitted to the non-volatile (NV) memory to be stored therein and preferably, the data is stored in the non-volatile memory.

In an operation S106 of the second branch, the received data may be processed to meet the requirements of the mass storage. The data may have to be processed to meet the data structure of the mass storage. The processing may be an adapting, a mapping or a modifying of the data.

In an operation S107 of the second branch, the received data is transmitted to the mass storage to be stored therein and preferably, the data is stored in the mass storage.

Finally, in the operation S103, the data is stored in the non-volatile (NV) memory or the mass storage, respectively, and hence the operational sequence relating to a storing of the received data is completed. Preferably, the operational sequence is repeated beginning with operation S100.

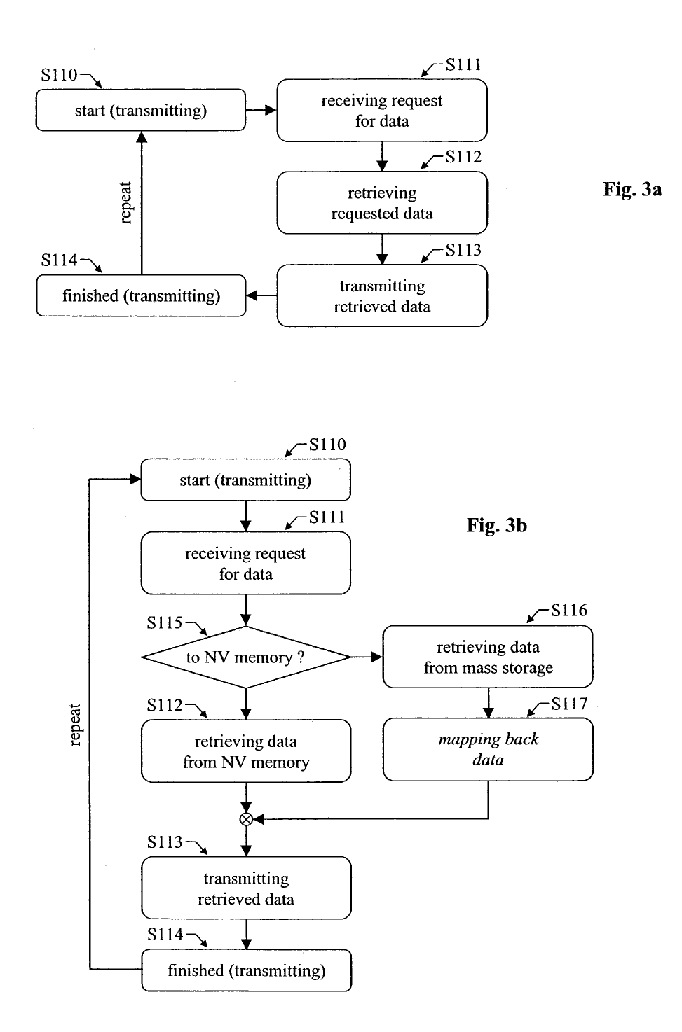

FIG. 3a and FIG. 3b illustrates exemplary operational sequences for retrieving electronic data of a mobile terminal device. FIG. 3a depicts a first exemplary operational sequence, whereas FIG. 3b depicts a second exemplary operational sequence which includes the exemplary operations of FIG. 3a and extends the described operational sequence by additional operations.

FIG. 3a illustrates an exemplary operational sequence for transmitting data to be retrieved with respect to an embodiment of the invention.

In an operation S110, an operational sequence for transmitting retrieved data is initiated. The operational sequence may be in a standby operational mode or halt mode, respectively, and the depicted operational sequence may be started when necessary, e.g. on a receiving of a request initiating the sequence or on a receiving of a corresponding dedicated signal.

In an operation S111, a request is received instructing to retrieve data from the non-volatile memory and to retransmit the retrieved data.

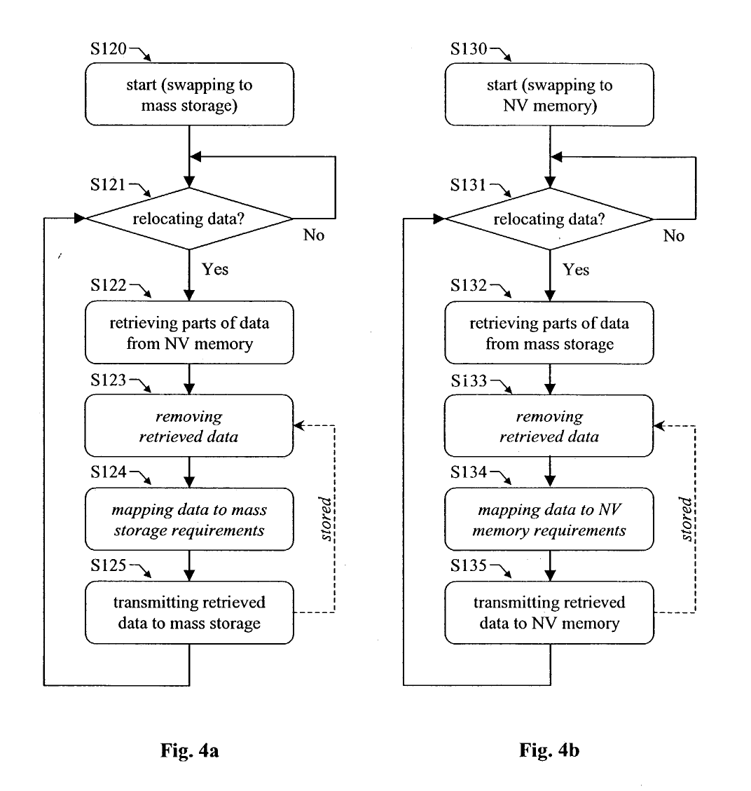

In an operation S112, the data is retrieved from the non-volatile memory. It may be possible that the data is not available in the non-volatile memory since it is swapped to the mass storage. The swapping of data is described in detail with reference to the following FIG. 4a and FIG. 4b. An intermediate swapping operation will make the data to be retrieved available.

In an operation S113, the retrieved data is retransmitted in accordance with the request. The request can contain a retransmission address information.

In an operation S114, the data is retrieved from the non-volatile memory and retransmitted. Hence the operational sequence relating to a transmitting of retrieved data is completed. Preferably, the operational sequence is repeated beginning with operation S110.

FIG. 3b illustrates an exemplary operational sequence for transmitting data to be retrieved with respect to an enhanced embodiment of the invention.

In an operation S110, an operational sequence for transmitting retrieved data is initiated. The operational sequence may be in a standby operational mode or halt mode, respectively, and the depicted operational sequence may be started when necessary, e.g. on a receiving of a request initiating the sequence or on a receiving of a corresponding dedicated signal.

In an operation S111, a request is received instructing to retrieve data from the fixed memory, i.e. the non-volatile memory or the mass storage, respectively, and to retransmit the retrieved data.

In an operation S115, the operational sequence branches into two branches. The first branch contains an operations S112, wherein this operation S112 relates to the retrieving of data from the non-volatile memory. The second branch contains operations S116 and S117 and relates to directly retrieving of data from the mass storage by ignoring the non-volatile memory.

The branching of the operational sequence refers back to the specifying of the data storage place during the storing operation presented in FIG. 1b. The data is retrieved corresponding to its assigned storage place. Conveniently, information relating the storage place may be received in combination with the request or may be included in the request. The information instructs to retrieve the data from either the non-volatile (NV) memory or the mass storage.

In an operation S112 of the first branch, the data is retrieved from the non-volatile memory. It may be possible that the data is not available in the non-volatile memory since it is swapped to the mass storage. The swapping of data is described in detail with reference to the following FIG. 4a and FIG. 4b. An intermediate swapping operation will make the data to be retrieved available.

In an operation S116 of the second branch, the data is directly retrieved from the mass storage.

In an operation S117 of the second branch, the retrieved data may be processed to meet the requirements of the receiving entity. The data may have to be processed to meet the data structure of the receiving entity. The processing may be an adapting, a mapping or a modifying of the data.

Finally in an operation S113, the data retrieved from the non-volatile memory is retransmitted in accordance with the request. The request can contain a retransmission address information. And in an operation S114, the data is retrieved from the non-volatile memory or the mass storage, respectively, and retransmitted. Hence the operational sequence relating to a transmitting of retrieved data is completed. Preferably, the operational sequence is repeated beginning with operation S110.

Overall, the storage algorithm can further take account of several different aspects improving the overall function of the fixed memory by distributing the data upon the members of the fixed memory. Certain data is assigned to the non-volatile memory such that this data is always fast accessible. Correspondingly, certain other data is assigned always to the mass storage in order to use economically a limited memory capacity of the fast accessible non-volatile memory.

Further, the distribution of the data to be stored can be operated in accordance with a priority rating or rating in accordance with the number of accesses. The more often data is accessed, i.e. read and/or written, the higher its rating. A priority rating can be derived from the application handling the data or can be provided by the application handling the data. Advantageously, data of high priority are preferably stored in the non-volatile memory.

Further advantageously, the distribution of data to be stored in fixed memory takes the consumption of power into account. An adequate adapted basic storage algorithm is for example able to operate a mass storage having a high consumption of power in an economic way.

The following operational sequences shown in FIG. 4a and FIG. 4b relate to the data exchange between the non-volatile memory and the mass storage. These operational sequences may be operated simultaneously to each other and in parallel to the operational sequences concerning the data receiving illustrated in FIG. 2a and FIG. 2b as well as operational sequences concerning the data transmitting illustrated with reference to FIG. 3a and FIG. 3b.

FIG. 4a illustrates a first exemplary operational sequence for swapping data in between non-volatile memory and mass storage according to an embodiment of the invention.

In an operation S120, the swapping of data from the non-volatile memory to the mass storage is initiated. The swapping operation may be initiated automatically with the presence of data in the non-volatile memory and the availability of a mass storage for swapping data.

In an operation S121, a dedicated algorithm determines if data is stored in the non-volatile memory and which should be relocated to the mass storage. If data to be relocated is identified, the operational sequence is continued with operation S122. Preferably, if no data to be relocated is identified the operation S121 is repeated. The repetition of operation S121 may be interrupted by a certain period of time.

In an operation S122, the identified data to be swapped is retrieved from the non-volatile memory. The identified data is at least a part of the total data stored in the non-volatile memory.

In an operation S123, the retrieved data is removed or deleted/erased from the non-volatile memory. The removing may be operated in combination with the following operation S125 in order to ensure the integrity of the stored data.

In an operation S124, the received data may be processed to meet the requirements of the mass storage. The data may have to be processed to meet the data structure of the mass storage. The processing may be an adapting, a mapping or a modifying of the data.

In an operation S125, the retrieved data is transmitted to the mass storage to be stored therein. A successful storing of the retrieved data in the mass storage may cause a signal upon which the retrieved data is removed and deleted from the non-volatile memory illustrated in the operation S123.

Preferably, the operational sequence returns to operation S121 for further identifying data to be swapped to the mass storage.

FIG. 4b illustrates a second exemplary operational sequence for swapping data in between non-volatile memory and mass storage according to an embodiment of the invention.

In an operation S130, the swapping of data from the mass storage to the non-volatile memory is initiated. The swapping operation may be initiated automatically with the presence of data in the mass storage or in case of requiring part of the data within the non-volatile memory for retransmitting.

In an operation S131, a dedicated algorithm determines if data is stored in the mass storage and which should be relocated to the non-volatile memory. If data to be relocated is identified, the operational sequence is continued with operation S132. Preferably, if no data to be relocated is identified the operation S131 is repeated. The repetition of operation S131 may be interrupted by a certain period of time.

In an operation S132, the identified data to be swapped is retrieved from the mass storage. The identified data is at least a part of the total data stored in the mass storage.

In an operation S133, the retrieved data is removed or erased from the mass storage. The removing may be operated in combination with the following operation S135 in order to ensure the integrity of the stored data.

In an operation S134, the received data may be processed to meet the requirements of the non-volatile memory. The data may have to be processed to meet the data structure of the non-volatile memory. The processing may be an adapting, a mapping or a modifying of the data.

In an operation S135, the retrieved data is transmitted to the non-volatile memory to be stored therein. A successful storing of the retrieved data in the non-volatile memory may cause a signal on which the retrieved data is removed from the mass storage illustrated in the operation S133.

Preferably, the operational sequence returns to operation S131 for further identifying data to be swapped to the non-volatile memory.

The swapping operation of data in between the non-volatile memory and the mass storage is described in very simplified operational sequences. The performance of the swapping operations depend on the quality of the identifying of data to be swapped as described with reference to operation S121 and S131 of FIG. 4a and FIG. 4b, respectively. The swapping of data in such a manner that the data integrity is maintained even in case of a power failure may require complex operations.

Overall, the swapping algorithm can further take account of several different aspects improving the overall function of the fixed memory. Certain data can persist in the non-volatile memory such that this data is always fast accessible. Correspondingly, certain data is swapped always to the mass storage in order to use economically a limited memory capacity of the fast accessible non-volatile memory.

Further, the data stored in the non-volatile memory can be swapped in accordance with a priority rating or rating in accordance with the number of accesses. The more often data is accessed, i.e. read and/or written, the higher its rating. A priority rating can be derived from the application handling the data or can be provided by the application handling the data. Advantageously, data of high priority are preferably stored in the non-volatile memory or are excluded from the swapping operation, respectively. An additional speculation algorithm can be used in order to swap data from the mass storage to the non-volatile memory prior to the requesting of the data. Such a speculation algorithm can implement a forward reading or a blockwise reading of data such as known from cache algorithms for cache memories of hard discs.

Further advantageously, the swapping operation of data in between the non-volatile memory and the mass storage takes the consumption of power into account. An adequate adapted basic swapping algorithm is for example able to operate a mass storage having a high consumption of power in an economic way.

The following figures illustrate different portable terminal devices according to embodiments of the invention. The components of the portable terminal devices relate to the components described with reference to FIG. 1a and FIG. 1b, respectively.

Preferably, the portable terminal devices may be mobile phones, personal digital assistants (PDA), organizers, handheld computers or the like. The portable terminal devices are able to execute corresponding applications. Again, the illustrated exemplary applications 10, 11 and 12 represent an arbitrary number of applications which are associated in an application framework 100. A storage system 200 is offered to the applications of the application framework 100 for accessing fixed memory. Further, the data flow between the application framework and the storage system is shown by a data flow path F10 analogous to the data flow path F10 referred in FIG. 1a and FIG. 1b, respectively.

The communication of the data flow between the non-volatile memory and the mass storage representing the fixed memory of the portable terminal devices is controlled by a fixed memory adapter 30 which preferably corresponds to the mass storage interface 26 or the common interface 28 illustrated in FIG. 1a or FIG. 1b, respectively.

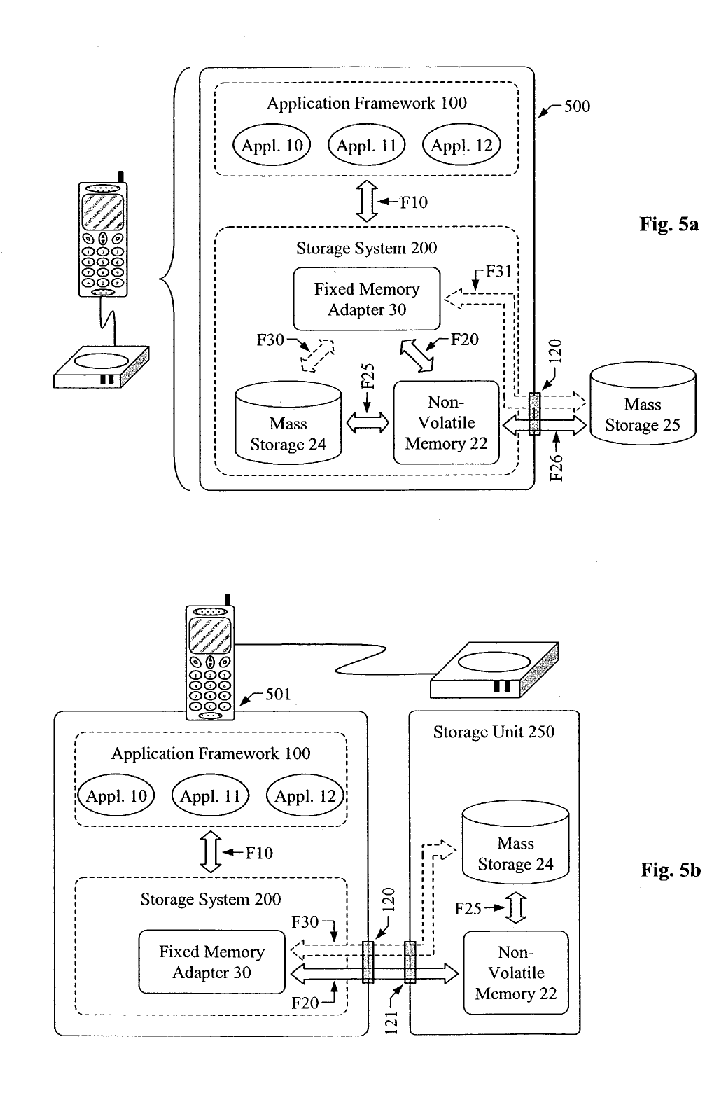

FIG. 5a shows a block diagram illustrating components of a mobile device having an external mass storage according to an embodiment of the invention. The depicted mobile device 500 contains both the non-volatile memory 22 and the mass storage 24. Additionally, the mobile device 500 is connected to an optional external mass storage 25, which is preferably detachably connected to the mobile device 500. A connector 120 allows the detachable connection of the external mass storage 25.

The fixed memory adapter 30 communicates with the non-volatile memory 22 via a data flow path F20. In accordance with the aforementioned method with respect to an embodiment of the invention, the handling of data of the fixed memory, i.e. reading and/or writing of data in the fixed memory, is obtained via the non-volatile memory 22. The swapping of data between non-volatile memory 22 and mass storage 24 according to the inventive concept is further communicated via the data flow path F25 illustrated in FIG. 5a. The data flow via data flow path F25 can be established via the data flow path F20 and a data flow path F30 which allows the direct exchange for data between the fixed memory adapter 30 and the mass storage 24 bypassing the non-volatile memory 22.

The mass storage 24 is depicted as an internal mass storage contained in the mobile device 500. Alternatively, a mass storage 25 externally connected and illustrated in FIG. 5a can also be used in combination with the non-volatile memory 22 in an analogous way. The data flow path F26 corresponds to the data flow path F25 illustrating the data flow due to swapping operations between them. Further analogously, the data flow via data flow path F26 can be established via the data flow path F20 and a data flow path F31 which allows the direct exchange for data between the fixed memory adapter 30 and the mass storage 25 bypassing the non-volatile memory 22.

Advantageously, the fixed memory adapter 30 contains the non-volatile memory 22 and offers a extension connector for plugging on a mass storage such a mass storage 24 or mass storage 25. Therefore, the fixed memory adapter 30 further contains a corresponding mass storage controller dedicated for operating the mass storage. A selection of possible embodiments of the mass storage and the corresponding mass storage controller or mass storage standard, respectively, is described above with reference to FIG. 1a and FIG. 1b.

FIG. 5b shows a block diagram illustrating components of a system comprising a mobile device and a mass storage unit according to an embodiment of the invention. Both the non-volatile memory 22 and the mass storage 24 included in a common storage unit 250 are externally connected to the mobile terminal device 501. Preferably, the common storage unit 250 is detachably connected to the mobile device 501. More preferably, the detachable storage unit 250 is connected via a connector 120 of the mobile device 510 and a connector 121 of the storage unit 250.

The fixed memory adapter 30 communicates with the non-volatile memory 22 via a data flow path F20. In accordance with the aforementioned method with respect to an embodiment of the invention, the handling of data of the fixed memory, i.e. reading and/or writing of data in the fixed memory, is obtained via the non-volatile memory 22. The swapping of data between non-volatile memory 22 and mass storage 24 according to the inventive concept is further communicated via the data flow path F25 illustrated in FIG. 5b. The data flow via data flow path F25 can be established via the data flow path F20 and a data flow path F30 which allows the direct exchange for data between the fixed memory adapter 30 and the mass storage 24 bypassing the non-volatile memory 22.

In a further embodiment of the fixed memory adapter 30 of FIG. 5b, the memory adapter 30 communicates with the non-volatile memory as well as with the mass storage. The swapping of data between non-volatile memory 22 and mass storage 24 of the storage unit 250 is controlled by the memory adapter 30, i.e. the data flow of the data flow path F25 is passed on by the memory adapted 30 via the data flow paths F20 and F30.

Further advantageously, the fixed memory adapter 30 is additionally connected to a non-volatile memory (not shown) contained in the mobile device or contained in the fixed memory adapter 30, respectively. Such a non-volatile memory arranged internal of the mobile device is operated analogously as described above with reference to FIG. 5a and the storage unit 250 may be operated as a mass storage 24 or a mass storage 25 described above.

The fixed memory adapter 30 may be constituted by a data processing component or a hardware circuit which may be comprised by the mobile device. Further, the fixed memory adapter 30 may be constituted by a code section for executing on the mobile device containing instructions for carrying out the necessary processing operations. Moreover, the fixed memory adapter 30 may be constituted by a portion of the mobile device. Additionally, the fixed memory adapter 30 may be constituted by hybrid system comprising a data processing component or a hardware circuit and a code section for executing on the mobile device containing instructions for carrying out the necessary processing operations in combination with the data processing component or a hardware circuit.

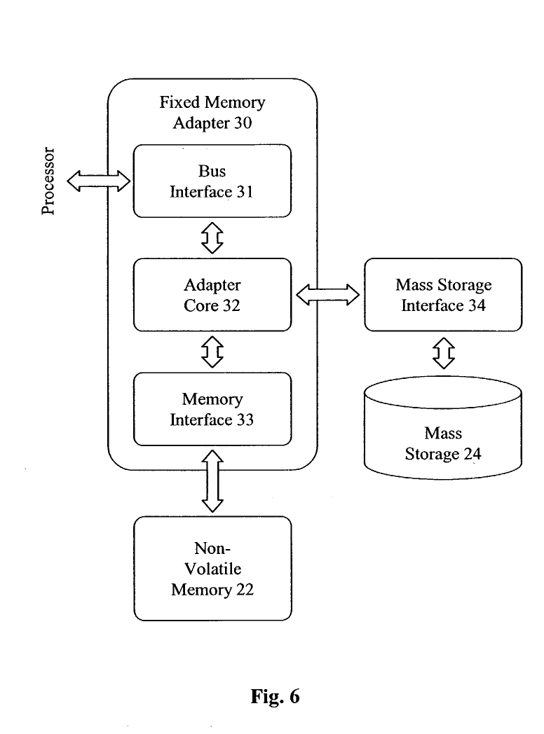

The following FIG. 6 illustrates components of a fixed memory adapter 30 according to an embodiment of the invention. The fixed memory adapter 30 includes a bus interface 31, an adapter core 32, a non-volatile memory interface 33. The arrows depicted in the FIG. 6 illustrate the data flows between the components of the fixed memory adapter 30.

The adapter core 32 communicates data between the bus interface 31, the non-volatile memory interface 33 and a mass storage interface 34.

The bus interface 31 enables the receiving of data to be stored in the fixed memory and information specifying the storage place, i.e. preferably the non-volatile memory 22 and the mass storage 24, the receiving of requests for data to be retrieved from the fixed memory and for transmitting retrieved data in accordance to a request for data. The bus interface 31 connects the fixed memory adapter 30 to a processing entity, i.e. a microprocessor executing the applications of the application framework, of the mobile device including the fixed memory adapter 30 preferably via a data communication bus (not shown).

The non-volatile memory interface 33 connects the fixed memory adapter 30 to a non-volatile memory 22 for data handling therein. The non-volatile memory 22 is externally connected to the fixed memory adapter 30 preferably via a dedicated data communication bus (not shown) but can also be implemented within the fixed memory adapter 30. The non volatile memory interface 33 is at least able to transmit data to the non-volatile memory 22 to be stored therein, to retrieve data from the non-volatile memory 22 and to delete data in the non-volatile memory 22.

The mass storage interface 34 connects the fixed memory adapter 30 to a mass storage 24 for data handling therein. The mass storage interface 34 is externally connected to the fixed memory adapter 30 preferably via a dedicated data communication bus (not shown) but can also be implemented within the fixed memory adapter 30. Further, the mass storage interface 34 communicates with the mass storage 24 via a further dedicated data communication bus (not shown). This dedicated data communication bus can be based on a typical mass storage bus of state of the art such as a universal serial bus (USB), a Firewire bus or a wireless Bluetooth connection, but also can be based on a proprietary basic connecting bus. The mass storage interface is at least able to transmit data to the mass storage 24 to be stored therein, to retrieve data from the mass storage 24 and to delete data in the mass storage 24.

The adapter core 32 controls the data flow in the fixed memory adapter in between the connected interfaces 31, 33 and 34, that is, in between the processing entity of the mobile device or the applications executed by the processing entity, respectively, and the fixed memory comprising the non-volatile memory 22 and the mass storage 24.

The adapter core 32 is adapted to execute the operational sequences described with reference to the method for handling data in a fixed memory of a mobile device according to an embodiment of the invention.

In case of a storing operation, the adapter core 32 is able to pass on data received by the bus interface 31 to the non-volatile memory interface 33 to be stored in the non-volatile memory 22 and alternatively to pass on data received by the bus interface 31 to the mass storage interface 34 to be stored in the mass storage 24. The distribution of the data basing on the aforementioned storage algorithm is performed and controlled by the adapter core 32. Further, the adapter core 32 is able to operate simultaneously the swapping of data from the non-volatile memory 22 to the mass storage 24, i.e. the retrieving of data from the non-volatile memory 22 via the non-volatile memory interface 33 and transmitting this retrieved data to the mass storage 24 via the mass storage interface 34.

In case of a reading operation, the adapter core 32 is able to retrieve data from the non-volatile memory 22 via the non-volatile memory interface 33 or the mass storage 24 via the mass storage interface 34 in accordance with a request received via the bus interface 31. The adapter core 32 operates the retrieving of the data from either the non-volatile memory 22 or mass storage 24 in accordance with the previous assigning of the storage place during the storing operation. Subsequently, the retrieved data is transmitted via the bus interface 31. Further, the adapter operates simultaneously the swapping operation of data, i.e. a part of the data to be retrieved from the non-volatile memory 22 is retrieved from the mass storage via the mass storage interface 34 and transmitted to the non-volatile memory 22 via the non-volatile memory interface 33 prior to the retrieving of the data from the non-volatile memory 22 in accordance with the request for data.

Further, the adapter core 32 is able to operate simultaneously the swapping of data from the mass storage 24 to the non-volatile memory 22, i.e. the retrieving of data from the mass storage 24 via the mass storage interface 34 and transmitting this retrieved data to the non-volatile memory 22 via the non-volatile memory interface 33.

Advantageously, the adapter core 32 is adapted to operate the aforementioned caching or relocating algorithm, respectively, for enhancing the swapping operation in between the non-volatile memory 22 and the mass storage 24.

The adapter core 32, bus interface 31, the mass storage interface 34 and the non-volatile memory interface 33 may be constituted by a data processing component or a hardware circuit which may be comprised by the mobile device. Further, the adapter core 32, bus interface 31, the mass storage interface 34 and the non-volatile memory interface 33 may be constituted by a code section for executing on the mobile device containing instructions for carrying out the necessary processing operations. Moreover, the adapter core 32, fixed bus interface 31, the mass storage interface 34 and the non-volatile memory interface 33 may be constituted by a portion of the mobile device. Additionally, the adapter core 32, fixed bus interface 31, the mass storage interface 34 and the non-volatile memory interface 33 may be constituted by hybrid system comprising a data processing component or a hardware circuit and a code section for executing on the mobile device containing instructions for carrying out the necessary processing operations in combination with the data processing component or a hardware circuit.

It is to be understood that even though numerous characteristics and advantages of various embodiments of the present invention have been set forth in the foregoing description, together with details of the structure and functions of various embodiments of the invention, this disclosure is illustrative only, and changes may be made in detail, especially in matter of the structure and arrangements of parts within the principles of the present invention to the full extend indicated by the broad general meaning of the terms in which the appended claims are expressed. For example, the particular elements may vary depending on the particular application for the non-volatile memory and the mass storage while maintaining substantially the same functionality without departing from the scope and the spirit of the present invention. Further, although the invention has been illustrated as implemented in circuit block and flow diagram, those skilled in the art will recognize that the invention may be implemented in any hardware, software or hybrid systems.

1. A method for handling data in a fixed memory associated with a mobile device (500, 510), wherein said fixed memory includes at least one non-volatile memory (22) and at least one mass storage (24, 25), wherein
said mobile device comprises a memory adapter connecting said fixed memory and an operation of storing (S100) data in said fixed memory comprises:
receiving (S101) said data to be stored in said fixed memory;
determining (S105) if said received data is to be stored in said at least one non-volatile memory (22) or in said at least one mass storage (24, 25);
in case said received data is to be stored in said non-volatile memory (22):
transmitting (S102) said received data to said at least one non-volatile memory (22) for storing; and
in case said received data is to be stored in said mass storage (24, 25):
transmitting (S107) said received data to said at least one mass storage (24, 25) to be stored.

2. A method according to claim 1, comprising
retrieving (S122) at least a part of said stored data from said at least one non-volatile memory (22); and
transmitting (S125) said retrieved data to said at least one mass storage (24, 25) to be stored.

3. A method according to claim 2, wherein said retrieving (S122) of at least a part of said stored data from said at least one non-volatile memory (22) comprises:
removing (S123) said at least a part of said stored data from said at least one non-volatile memory.

4. A method according to claim 2, wherein said retrieving (S122) of at least a part of said stored data from said at least one non-volatile memory (22) comprises:
processing (S124) said retrieved data to meet properties of said mass storage (24, 25).

5. A method according to claim 2, wherein said retrieving (S122) of at least a part of said stored data from said at least one non-volatile memory (22) comprises:
identifying (S121) at least a part of said stored data in accordance with a relocating algorithm.

6. A method according to claim 1, wherein an operation of reading (S110) data from said fixed memory comprises:
receiving (S111) a request instructing to retrieve data from said fixed memory and to transmit said retrieved data;
determining (S115) if said requested data is to be retrieved from said at least one non-volatile memory (22) or from said at least one mass storage (24, 25);
in case said request data is to be retrieved from said at least one non-volatile memory (22):
retrieving (S112) said data from said non-volatile memory (22) in accordance with said request;
transmitting (S113) said retrieved data in accordance with said request;
in case said request data is to be retrieved from said at least one mass storage (24, 25):
retrieving (S116) said data from said at least one mass storage (24, 25); and
transmitting (S113) said retrieved data.

7. A method according to claim 6, comprising:
retrieving (S132) at least a part of said requested data from said mass storage (24, 25); and
transmitting (S135) said retrieved part of data to said non-volatile memory (22) to be stored.

8. A method according to claim 7, wherein said retrieving (S132) of at least a part of said data from said mass storage (24, 25) comprises:
removing (S123) said at least a part of said data to be retrieved from said mass storage (24, 25).

9. A method according to claim 7, wherein said retrieving (132) of at least a part of said data to be retrieved from said mass storage (24, 25) comprises:
processing (S134) said at least a part of said data to meet properties of said non-volatile memory (22).

10. A method according to claim 7, wherein said retrieving (S132) of at least a part of said data to be retrieved from said mass storage (24, 25) comprises:
identifying (S131) of at least a part of said stored data in accordance with said relocating algorithm.

11. A software tool for handling data in a fixed memory of a mobile device, comprising program code portions for carrying out the operations of claim 1, when said program is implemented in a computer program for executing on a processing device, a mobile device, a mobile terminal device or a network device.

12. A computer program for handling data in a fixed memory of a mobile device, comprising program code section for carrying out the operations of claim 1, when said program is run on a processing device, a mobile device, a mobile terminal device or a network device.

13. A computer program product for handling data in a fixed memory of a mobile device, wherein said computer program product is comprising program code sections stored on a computer readable medium for carrying out the method of claim 1, when said program product is run on a processing device, a mobile device, a mobile terminal device or a network device.

14. A memory adapter (26, 28, 30) for handling data in a fixed memory of a mobile device (500, 510), wherein said fixed memory comprises at least one non-volatile memory (22) and at least one mass storage (24, 25) and said memory adapter (26, 28, 30) is connected to said fixed memory, comprising:
a component for receiving (31) data to be stored in said fixed memory;
a component for handling (32) said received data;
a component for transmitting (33) said received data to said at least one non-volatile memory (22) to be stored; and
a component for transmitting (34) said received data to said at least one mass storage (24, 25) to be stored.

15. A memory adapter according to claim 14, wherein data of said mobile device is handled through said memory adapter in said fixed memory acting as one memory regardless of a number of components comprised in said fixed memory.

16. A memory adapter according to claim 14, comprising components for executing the operations of the method according to claim 1.

17. A memory adapter according to claim 14, wherein said memory adapter contains said non-volatile memory (22).

18. A mobile device (500, 501) connected to a fixed memory and having a memory adapter (26, 28, 30) for handling data in said fixed memory of the mobile device (500, 501), wherein said fixed memory comprises at least one non-volatile memory (22) and at least one mass storage (24, 25) and said memory adapter (26, 28, 30) is connected to said at least one non-volatile memory (22) and to said at least one mass storage (24, 25),
wherein said memory adapter (26, 28, 30) comprises:
a component for receiving (31) data to be stored in said fixed memory;
a component for handling (32) said received data;
a component for transmitting (33) said received data to said at least one non-volatile memory (22) to be stored; and
a component for transmitting (34) said received data to said at least one mass storage (24, 25) to be stored.

19. A mobile device according to claim 18, wherein said memory adapter (26, 28, 30) is a memory adapter according to claim 14.

20. A mobile device according to claim 18, wherein said non-volatile memory (22) is contained in said mobile device (500).

21. A mobile device according to claim 18, wherein said mass storage (24, 25) is externally detachably connected to said mobile device (500, 501).

22. A mobile device according to claim 18, wherein said mobile device (500, 510) is a mobile terminal device.

23. A system for handling data in a fixed memory of a mobile device comprises a mobile device providing data, the fixed memory and a memory adapter (26, 28, 30), wherein said fixed memory comprises at least one non-volatile memory (22) and at least one mass storage (24, 25) and said memory adapter (26, 28, 30) is connected to said at least one non-volatile memory (22) and to said at least one mass storage (24, 25)
wherein said memory adapter (26, 28, 30) comprises:
a component for receiving (31) data to be stored in said fixed memory;
a component for handling (32) said received data;
a component for transmitting (33) said received data to said at least one non-volatile memory (22) to be stored; and
a component for transmitting (34) said received data to said at least one mass storage (24, 25) to be stored.

24. A system according to claim 23, wherein said memory adapter (26, 28, 30) is a memory adapter according to claim 14.

25. A system according to claim 23, wherein said mobile device (500, 501) is a mobile device according to claim 18.
